(19) United States
(12) Patent Application Publication
(10) Pub. No.: US 2010/0164467 A1
(43) Pub. Date: Jul. 1, 2010

(54) REFERENCE VOLTAGE GENERATION CIRCUIT

(76) Inventor: Eun-Sang Jo, Bucheon-si (KR)

Correspondence Address: SHERR & VAUGHN, PLLC, 620 HERNDON PARKWAY, SUITE 320, HERNDON, VA, 20170, US

(21) Appl. No.: 12/648,870

(22) Filed: Dec. 29, 2009

(30) Foreign Application Priority Data
Dec. 29, 2008 (KR) 10-2008-0135176

(51) Int. Cl. G05F 3/16

(52) U.S. Cl. 323/313

(57) ABSTRACT

A reference voltage generation circuit includes an operational amplifier for outputting a constant voltage in accordance with reference voltages respectively input to an inverting terminal of the operational amplifier and a non-inverting terminal of the operational amplifier, and a start-up circuit for waking up the operational amplifier when the start-up circuit is switched from an idle mode to an active mode. The start-up circuit includes a first-type transistor having a gate connected to an output of the operational amplifier, a source connected to a supply voltage, and a drain connected to resistors, to supply a constant reference current to the resistors in accordance with an output voltage from the operational amplifier, thereby generating a band-gap output voltage. The resistors are connected in parallel to a stage, from which the band-gap output voltage is output, in order to generate a band-gap output voltage of about 0.6V.

The present application claims priority under 35 U.S.C. 119 to Korean Patent Application No. 10-2008-0135176 (filed on Dec. 29, 2008), which is hereby incorporated by reference in its entirety.

### BACKGROUND

It is beneficial that the internal biasing reference voltage of a semiconductor integrated circuit is stably maintained, in order to secure the reliability of the entirety of a device using the semiconductor integrated circuit. That is, it is beneficial that, even when an external supply voltage, ambient temperature, or processes are varied, the semiconductor integrated circuit is not affected by such a variation, in order to enable each element of the device to stably perform an intrinsic function thereof. To this end, it is beneficial to provide a reference voltage generation circuit capable of always supplying a stable and constant reference voltage.

Even in such a reference voltage generation circuit, however, there may be a factor causing the circuit itself to become unstable. Such a factor can, for example, be a variation in temperature, process condition or external supply voltage. One example of such a reference voltage generation circuit is a band-gap reference voltage generation circuit. The band-gap reference voltage generation circuit generates a voltage (potential) of a predetermined range even when there is a variation in temperature, supply voltage, or process condition.

FIG. 1 is a circuit diagram illustrating a related band-gap reference voltage generation circuit. Referring to FIG. 1, the related band-gap reference voltage generation circuit includes an operational amplifier 10 for outputting a constant voltage in accordance with reference voltages respectively input to an inverting terminal (−) thereof and a non-inverting terminal (+) thereof, a first PMOS transistor PM1 for outputting a bias current corresponding to an output voltage from the operational amplifier 10, using a supply voltage VDD, and a reference voltage circuit 20 for supplying the reference voltages to the inverting terminal (−) and non-inverting terminal (+) of the operational amplifier 10, respectively, using the bias current from the first PMOS transistor PM1. The related band-gap reference voltage generation circuit also includes a start-up circuit 30 for driving the entire circuit in a power-up operation, and an output terminal NO arranged between the first PMOS transistor PM1 and the reference voltage circuit 20.

The first PMOS transistor PM1 is switched in accordance with the output voltage of the operational amplifier 10. The first PMOS transistor PM1 includes a source connected to the supply voltage VDD, and a drain connected to the output terminal NO. The first PMOS transistor PM1 supplies the bias current corresponding to the output voltage from the operational amplifier 10 to the reference voltage circuit 20. The reference voltage circuit 20 is a temperature compensation circuit constituted by bipolar transistors and resistors. The reference voltage circuit 20 includes a first resistor R1 and a first bipolar transistor Q1, which are connected in series between the output terminal NO and a ground voltage VSS. The reference voltage circuit 20 also includes a second resistor R2, a third resistor R3, and a second bipolar transistor Q2, which are connected in series between the output terminal NO and the ground voltage VSS.

A first node N1 between the first resistor R1 and the first bipolar transistor Q1 is connected to the inverting terminal (−) of the operational amplifier 10. A second node N2 between the second resistor R2 and the third resistor R3 is connected to the non-inverting terminal (+) of the operational amplifier 10.

The bases of the first and second bipolar transistors Q1 and Q2 are connected to the ground voltage VSS such that the first and second bipolar transistors Q1 and Q2 constitute a current mirror. The emitter of the first bipolar transistor Q1 is connected to the first node N1, whereas the collector of the first bipolar transistor Q1 is connected to the ground voltage VSS. The emitter of the second bipolar transistor Q2 is connected to the third resistor R3, whereas the collector of the second bipolar transistor Q2 is connected to the ground voltage VSS.

In the reference voltage circuit 20 having the above-mentioned configuration, positive and negative reference voltages are supplied to the inverting terminal (−) and non-inverting terminal (+) of the operational amplifier 10, respectively, as a certain current flows to a source of the ground voltage VSS through the first and second bipolar transistors Q1 and Q2 connected in the form of a current mirror, in accordance with the resistance ratio among the first to third resistors R1, R2, R3. The operational amplifier 10 outputs a constant band voltage Vband in accordance with the reference voltages supplied from first and second nodes N1 and N2 of the reference voltage circuit 20.

A second PMOS transistor PM2 is connected to the supply voltage VDD in the form of a diode, to supply the supply voltage VDD to the first PMOS transistor PM1.

The start-up circuit 30 includes a third PMOS transistor PM3 controlled in accordance with a power-down signal pwd and connected to the supply voltage VDD, and a fourth PMOS transistor PM4 connected, at the source thereof, to a drain of the third PMOS transistor PM3. The gate and drain of the fourth PMOS transistor PM4 are connected to each other. The start-up circuit 30 also includes first to third NMOS transistors NM1 to NM3 connected in series to the fourth PMOS transistor PM4 in the form of diodes, a fifth PMOS transistor PM5 for outputting the output voltage of the operational amplifier 10 in accordance with gate voltages of the first to third NMOS transistors NM1 to NM3, and a fourth NMOS transistor NM4 controlled in accordance with an inverted power-down signal pwdb and connected to the fifth PMOS transistor PM5 and the ground voltage VSS.

The start-up circuit 30 starts up the entire circuit when it is turned on, or is switched from an idle mode to an active mode (normal mode). When the start-up circuit 30 is switched from the idle mode to the active mode, it wakes up the operational amplifier 10. The start-up circuit 30 also functions to make the band-gap reference voltage generation circuit have a stable wake-up point.

The related band-gap reference voltage generation circuit adds the voltage generated by a proportional to absolute temperature (PTAT) circuit and the voltage of a base-emitter junction having a negative temperature coefficient to each other, to output a stable reference voltage that is not affected by a variation in temperature. Meanwhile, the operational amplifier 10 of the band-gap reference voltage generation circuit having the above-mentioned configuration includes two input transistors connected to the inverting terminal (−) and non-inverting terminal (+) of the operational amplifier 10. If the two input transistors are manufactured to have the same size, a stable voltage may be output from the operational amplifier 10. That is, the operational amplifier 10 may output a constant band voltage Vband in accordance with the supplied reference voltages.

However, if the two input transistors provided in the operational amplifier 10 have a mismatch of about 0.11% or more, the operational amplifier 10 outputs a voltage of about 0.4V. In this case, the reference voltage generation circuit may not perform a desired reference voltage generation function.

FIG. 2 is a graph depicting band-gap output voltage characteristics of the related band-gap reference voltage generation circuit exhibited when the input transistors of the operational amplifier are mismatched. As shown in FIG. 2, the related band-gap reference voltage generation circuit outputs a stable reference voltage when the two input transistors of the operational amplifier 10 are realized in a process causing a mismatch A of 0%. However, when the two input transistors of the operational amplifier 10 have a mismatch B of about 0.11% or more, the output voltage of the operational amplifier 10 cannot increase to 1.0V or more. In this case, the operational amplifier 10 outputs a reference voltage of about 0.4V. For this reason, the related band-gap reference voltage generation circuit cannot perform a desired reference voltage generation function.

In detail, in the related band-gap reference voltage generation circuit, the output of the operational amplifier 10 has a high level when the start-up circuit 30 is in an idle mode. When the start-up circuit 30 is switched from the idle mode to the active mode (normal mode) under the condition that the two input transistors of the operational amplifier 10 have a mismatch beyond an allowable range due to a variation in process, or the start-up circuit 30 does not normally operate, the output voltage of the operational amplifier 10 is not set within a band gap, or still has a high level. For this reason, the start-up circuit 30 slowly wakes up when it is switched from the idle mode to the active mode. As a result, the related reference voltage generation circuit has poor performance in that the operational amplifier 30 may not have a stable wake-up point due to the delayed wake-up time of the start-up circuit 30.

### SUMMARY

Embodiments relate to a semiconductor integrated circuit, and more particularly, to a reference voltage generation circuit for generating a voltage of a predetermined range. Embodiments provide a reference voltage generation circuit capable of achieving fast start-up when it is switched from an idle mode to a normal mode, and providing a stable band-gap output voltage.

Embodiments provide a reference voltage generation circuit capable of supporting stable start-up when it is switched from an idle mode to a normal mode, and stably operating even when the characteristics of the elements of the reference voltage generation circuit are varied due to process mismatch.

Embodiments relate to a reference voltage generation circuit that includes: an operational amplifier for outputting a constant voltage in accordance with reference voltages respectively input to an inverting terminal of the operational amplifier and a non-inverting terminal of the operational amplifier; and a start-up circuit for waking up the operational amplifier when the start-up circuit is switched from an idle mode to an active mode, the start-up circuit comprising a first first-type transistor having a gate connected to an output of the operational amplifier, a source connected to a supply voltage, and a drain connected to first and second resistors, to supply a constant reference current to the first and second resistors in accordance with an output voltage from the operational amplifier, thereby generating a band-gap output voltage, wherein the first and second resistors are connected in parallel to a stage from which the band-gap output voltage is output.

The start-up circuit may also include a low pass filter having a second first-type transistor and a first second-type transistor, to remove radio-frequency noise from the band-gap output voltage, and a second second-type transistor for controlling the band-gap output voltage to be 0V in the idle mode. In particular, the second first-type transistor of the low pass filter may have a gate, and a source connected between the first and second resistors while being connected to the gate of the second first-type transistor. The second first-type transistor of the low pass filter has a drain connected to a gate of the first second-type transistor. The first second-type transistor may have a source connected to a ground voltage, and a drain connected to the ground voltage.

The start-up circuit may also include a second first-type transistor having a source connected to the supply voltage, a gate, and a drain connected to the gate of the second first-type transistor, the second first-type transistor being turned on when the start-up circuit is switched from the idle mode to the active mode, a first second-type transistor having a drain connected to the drain of the second first-type transistor, the first second-type transistor being turned off when the start-up circuit is switched from the idle mode to the active mode, thereby causing the supply voltage to be charged, as a drain voltage, in the drain of the first second-type transistor, a second second-type transistor having a gate connected to the drain of the second first-type transistor and the drain of the first second-type transistor, and a drain connected to the output of the operational amplifier, the second second-type transistor being turned on by the voltage charged in the drain of the first second-type transistor, and third and fourth second-type transistors each having a gate connected to a stage supplying an inverted power-down signal generated when the start-up circuit is switched from the idle mode to the active mode, the third and fourth second-type transistors being simultaneously turned on by the inverted power-down signal. The first second-type transistor may have a gate connected to the drain of the first first-type transistor, and a source connected to a drain of the fourth second-type transistor. The second second-type transistor may have a source connected to a drain of the third second-type transistor. Each of the third and fourth second-type transistors may have a source connected to a ground voltage. Third and fourth second-type transistors may be turned off by the inverted power-down signal in the idle mode. The first second-type transistor may be turned off by a band-gap output voltage of 0V generated in the idle mode.

The reference voltage generation circuit may also include second and third first-type transistors each having a source connected to the supply voltage, each of the second and third first-type transistors outputting a bias current corresponding to the output voltage from the operational amplifier, using the supply voltage, a reference voltage circuit comprising first and second nodes respectively connected to the inverting and non-inverting terminals of the operational amplifier, to supply the reference voltages to the inverting and non-inverting terminals of the operational amplifier via the first and second nodes, using the bias currents output from the second and third first-type transistors, respectively, and a fourth first-type transistor having a source connected to the supply voltage, a gate connected to a stage supplying an inverted power-down signal, the fourth first-type transistor supplying the supply voltage to the second and third first-type transistors in accordance with the inverted power-down signal. Each of the second and third first-type transistors may have a gate connected to the output of the operational amplifier. The second first-type transistor may have a drain connected to the first node of the reference voltage circuit. The third first-type transistor may have a drain connected to the second node of the reference voltage circuit. The fourth first-type transistor may have a drain connected to the gates of the second and third first-type transistors.

The reference voltage circuit may also include a third resistor and a first bipolar transistor which are connected in parallel to the first node and the ground voltage, a fourth resistor and a second bipolar transistor which are connected in parallel to the second node and the ground voltage, and a fifth resistor connected in series between the second node and the second bipolar transistor. The third resistor may be connected to the second first-type transistor in series. The fifth resistor may be connected to the third first-type transistor in series while being connected to the fourth resistor in parallel. The first and second bipolar transistors may have bases connected to the ground voltage, to constitute a current mirror. The first bipolar transistor may have an emitter connected to the first node, and a collector connected to the ground voltage. The second bipolar transistor may have an emitter connected to the fifth resistor, and a collector connected to the ground voltage. The fourth first-type transistor may be turned on in the idle mode, and the output of the operational amplifier may be charged with the supply voltage as the fourth first-type transistor is turned on, so that the second and third first-type transistors may be turned off.

The first first-type transistor may supply a constant reference current to the first and second resistors, to generate a band-gap output voltage of 0.6V. The first-type transistors may be P-channel type MOS transistors, and the second-type transistors may be N-channel type MOS transistors.

### DRAWINGS

FIG. 1 is a circuit diagram illustrating a related band-gap reference voltage generation circuit.

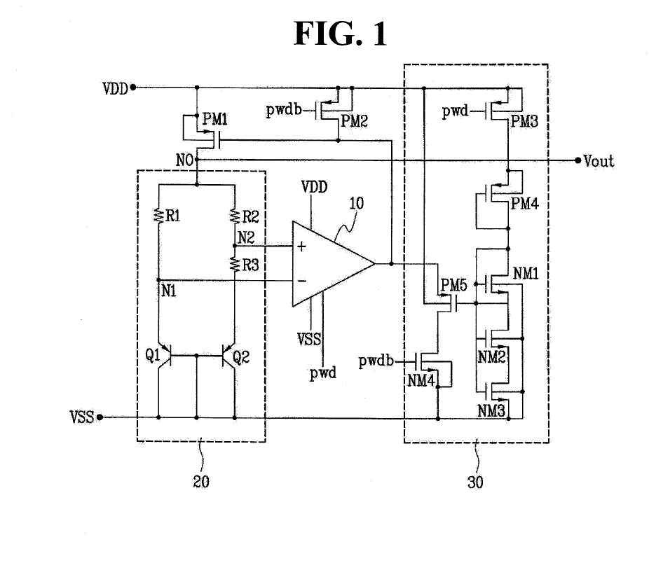

FIG. 2 is a graph depicting band-gap output voltage characteristics of the related band-gap reference voltage generation circuit exhibited when the input transistors of an operational amplifier are mismatched.

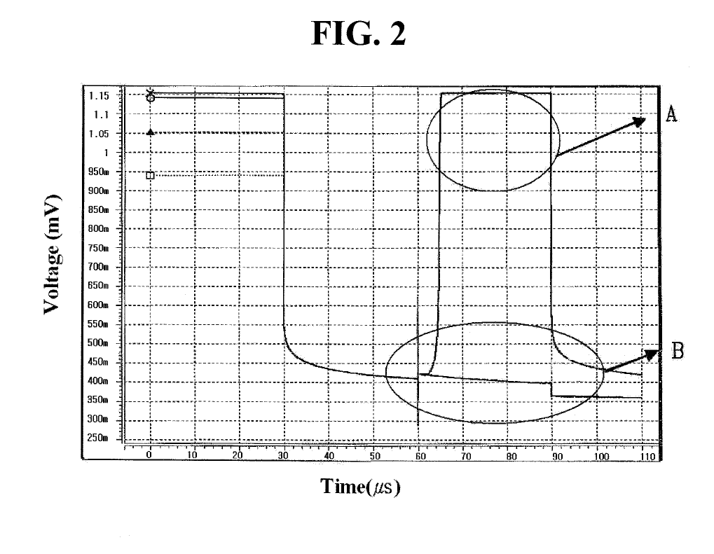

FIG. 3 is a circuit diagram illustrating a reference voltage generation circuit according to embodiments.

FIG. 4 is a simulation graph depicting a band-gap output from a band-gap reference voltage generation circuit according to embodiments.

FIG. 5 is a simulation graph depicting a band gap output of 0.6V generated when a supply voltage (VDD) ranges from 1.62V to 3.6V, in accordance with embodiments.

### DESCRIPTION

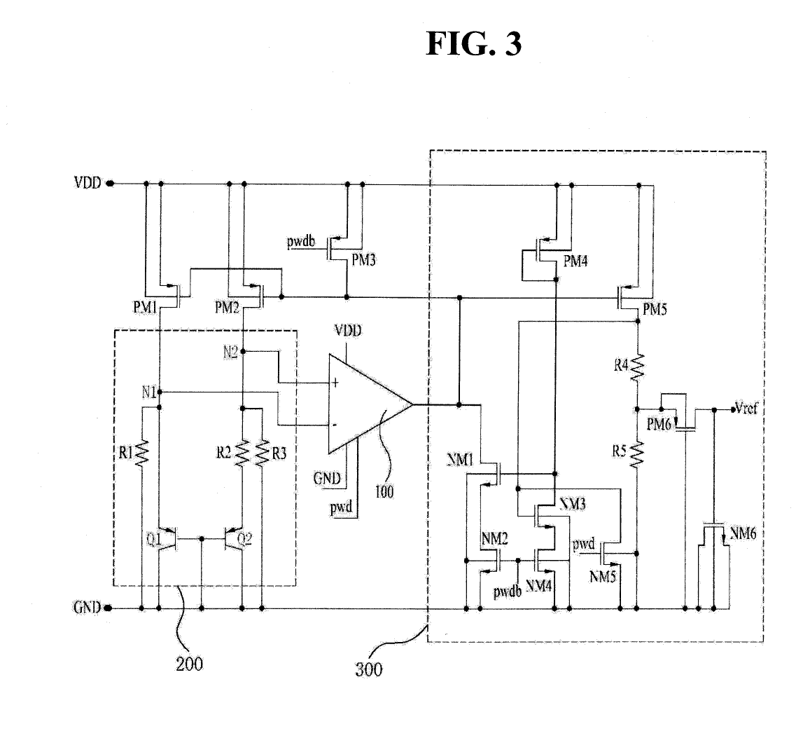

FIG. 3 is a circuit diagram illustrating a reference voltage generation circuit according to embodiments. In particular, the reference voltage generation circuit may be a band-gap reference voltage generation circuit. Referring to FIG. 3, the reference voltage generation circuit according to embodiments includes an operational amplifier 100 for outputting a constant voltage in accordance with reference voltages respectively input to an inverting terminal (−) thereof and a non-inverting terminal (+) thereof, a reference voltage circuit 200 for supplying the reference voltages to the inverting terminal (−) and non-inverting terminal (+) of the operational amplifier 100, respectively, and a start-up circuit 300 for waking up the operational amplifier 100 when the start-up circuit 300 is switched from an idle mode to an active mode.

The reference voltage generation circuit also includes PMOS transistors PM1 and PM2 for outputting bias currents corresponding to the output voltage from the operational amplifier 100, using a supply voltage VDD, and another PMOS transistor PM3 for supplying the supply voltage VDD to the PMOS transistors PM1 and PM2. Each of the PMOS transistors PM1 and PM2 is connected, at the source thereof, to the supply voltage VDD, and is connected, at the gate thereof, to an output of the operational amplifier 100.

The PMOS transistor PM1 is connected, at the drain thereof, to a first node N1 of the reference voltage circuit 200. The first node N1 is connected to the inverting terminal (−) of the operational amplifier 100. The PMOS transistor PM2 is connected, at the drain thereof, to a second node N2 of the reference voltage circuit 200. The second node N2 is connected to the non-inverting terminal (+) of the operational amplifier 100. The PMOS transistor PM3 is connected, at the drain thereof, to both the gates of the PMOS transistors PM1 and PM2.

The reference voltage circuit 200 supplies reference voltages to the inverting terminal (−) and non-inverting terminal (+) of the operational amplifier 100 via the first and second nodes N1 and N2, using bias currents output from the PMOS transistors PM1 and PM2, respectively. The PMOS transistor PM3 may be connected, at the source thereof, to the supply voltage VDD, and may be connected, at the gate thereof, to a stage for supplying an inverted power-down signal pwdb. Thus, the PMOS transistor PM3 supplies the supply voltage VDD to the PMOS transistors PM1 and PM2 in accordance with the inverted power-down signal pwdb. The signal pwdb represents a signal inverted from a power-down signal pwd. When the signal pwd has a high level, the signal pwdb has a low level. On the other hand, when the signal pwd has a low level, the signal pwdb has a high level.

The start-up circuit 300 includes a PMOS transistor PM5 for supplying a constant reference current to resistors R4 and R5 connected to the drain of the PMOS transistor PM5 in accordance with the output voltage from the operational amplifier 100, to generate a divided band-gap output voltage Vref. The resistors R4 and R5 may have the same resistance value. The PMOS transistor PM5 may be connected, at the gate thereof, to the output of the operational amplifier 100, and may be connected, at the source thereof, to the supply voltage VDD.

The start-up circuit 300 may further include a low pass filter, and an NMOS transistor NM5 for preventing consumption of power.

The low pass filter can include a PMOS transistor PM6 and an NMOS transistor NM6, and functions to remove radio-frequency noise from the band-gap output voltage Vref. In particular, the PMOS transistor PM6 of the low pass filter may be connected, at the source thereof, between the resistors R4 and R5. The source of the PMOS transistor PM6 may also be connected to the gate of the PMOS transistor PM6. The PMOS transistor PM6 may also be connected, at the drain thereof, to the gate of the NMOS transistor NM6. The source and drain of the NMOS transistor NM6 are connected to the ground voltage GND.

The NMOS transistor NM5 may be connected, at the drain thereof, to the drain of the PMOS transistor PM5. The NMOS transistor NM5 functions to control the band-gap output voltage Vref to be 0V, thereby preventing the entire circuit from consuming power. The NMOS transistor NM6 is driven in accordance with the power-down signal pwd. The source of the NMOS transistor NM6 may be connected to the ground voltage GND.

When the start-up circuit 300 is switched from the idle mode to the active mode (normal mode) or from the active mode to the idle mode, it makes the operational amplifier 100 have stable wake-up points for the input and output thereof. To this end, the start-up circuit 300 includes, in addition to the PMOS transistor PM3, another PMOS transistor PM4, and four NMOS transistors NM1, NM2, NM3, and NM4.

The PMOS transistor PM4 is turned on when the start-up circuit 300 is switched from the idle mode to the active mode. The PMOS transistor PM4 is connected, at the source thereof, to the supply voltage VDD. The gate and drain of the PMOS transistor PM4 are connected to each other. The NMOS transistor NM3 is turned off when the start-up circuit is switched from the idle mode to the active mode. The NMOS transistor NM3 is connected, at the drain thereof, to the drain of the PMOS transistor PM4. Accordingly, when the NMOS transistor NM3 is turned off, the supply voltage VDD is charged for the drain voltage of the NMOS transistor NM3.

The NMOS transistor NM1 may be connected, at the gate thereof, to both the drains of the PMOS transistor PM4 and NMOS transistor NM3. The drain of the NMOS transistor NM1 may be connected to the output of the operational amplifier 100. Thus, the NMOS transistor NM1 may be turned on by the voltage VDD charged in the drain of the NMOS transistor NM3.

The NMOS transistors NM2 and NM4 are simultaneously turned on as the inverted power-down signal pwdb output when the start-up circuit 300 is switched from the idle mode to the active mode is input to the NMOS transistors NM2 and NM4. The gates of the NMOS transistors NM2 and NM4 may be connected in common to the supply stage for the inverted power-down signal pwdb.

Hereinafter, one example connection structure of the four NMOS transistors NM1, NM2, NM3, and NM4 will be described in more detail. The gate of the NMOS transistor NM3 is connected to the drain of the PMOS transistor MP5. The source of the NMOS transistor NM3 is connected to the drain of the NMOS transistor NM4. The source of the NMOS transistor NM1 is connected to the drain of the NMOS transistor NM2. The sources of the NMOS transistors NM2 and NM4 are connected to the ground voltage GND.

Thus, when the start-up circuit 300 is switched from the idle mode to the active mode, the output from the operational amplifier 100 is discharged from the level of the supply voltage VDD to a level of “VDD−1”V corresponding to a desired wake-up point of the reference voltage generation circuit. When the start-up circuit 300 is switched from the idle mode to the active mode, the PMOS transistor PM4, NMOS transistor NM3, NMOS transistor NM1, NMOS transistors NM2 and NM4, and operational amplifier 100 operate continuously until the band-gap output voltage Vref is stabilized, namely, reaches about 0.6V.

When the band-gap output voltage Vref reaches about 0.6V, the NMOS transistor NM3 is turned on, so that the drain voltage of the NMOS transistor NM3 corresponds to 0V. When the drain voltage of the NMOS transistor NM3 corresponds to 0V, the NMOS transistor NM1 is turned off. At this time, the start-up circuit 300 ceases operation thereof.

On the other hand, when the start-up circuit 300 is in an idle mode, the NMOS transistors NM2 and NM4 are turned off by the inverted power-down signal pwdb. Also, the NMOS transistor NM3 is turned off by the band-gap output voltage Vref, which is about 0V in the idle mode. As a result, the total current consumption of the reference voltage generation circuit in the idle mode is about 0 μA.

The reference voltage circuit 200 can include resistors R1, R2, and R3, and bipolar transistors Q1 and Q2. Hereinafter, one example structure of the reference voltage circuit 200 will be described in conjunction with the first node N1 connected to the inverting terminal (−) of the operational amplifier 100 and the second node N2 connected to the non-inverting terminal (+) of the operational amplifier 100.

The resistor R1 and first bipolar transistor Q1 may be connected in parallel to the first node N1 and ground voltage GND. The resistor R1 may be connected to the PMOS transistor PM1 in series. The resistor R3 and second bipolar transistor Q2 may be connected in parallel to the second node N2 and ground voltage GND. The resistor R2 may be connected between the second node N2 and the second bipolar transistor Q2. The resistor R2 may be connected to the PMOS transistor PM2 in series while the resistors R2 and R3 may be connected in parallel.

The first and second bipolar transistors Q1 and Q2 may be connected, at the bases thereof, to the ground voltage GND such that they constitute a current mirror. The first bipolar transistor Q1 is connected, at the emitter thereof, to the first node N1, and is connected, at the collector thereof, to the ground voltage GND. The second bipolar transistor Q2 is connected, at the emitter thereof, to the resistor R2, and is connected, at the collector thereof, to the ground voltage GND.

The PMOS transistor PM3 is turned on when the start-up circuit 300 is in the idle mode. As the PMOS transistor PM3 is turned on, the output of the operational amplifier 100 is charged with the supply voltage VDD. As a result, the PMOS transistors PM1 and PM2 are turned off.

In the above-described reference voltage generation circuit according to embodiments, the PMOS transistor PM5 supplies a constant reference current to the resistors R4 and R5, which, in turn, carry out voltage division, thereby generating a band-gap output voltage Vref of about 0.6V. In particular, when the start-up circuit 300 is switched from the idle mode to the active mode, the band-gap output voltage Vref is rapidly set to about 0.6V, and is then maintained at a certain level.

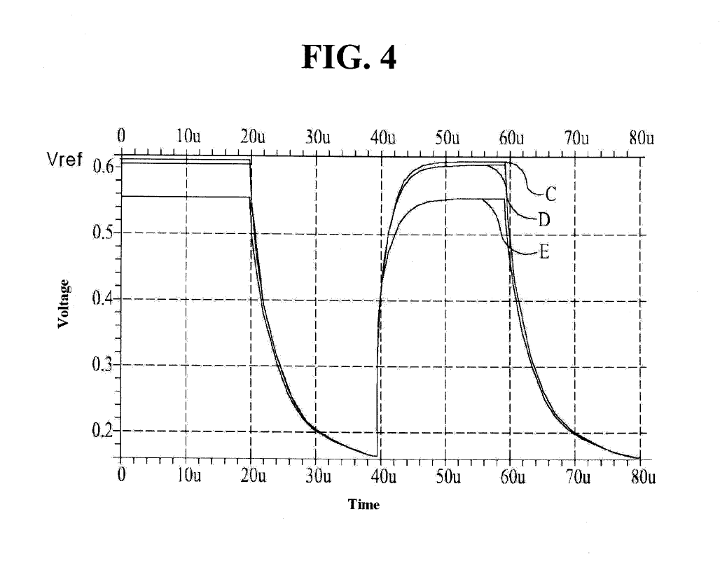

FIG. 4 is a simulation graph depicting the band-gap output from the band-gap reference voltage generation circuit according to embodiments. Referring to FIG. 4, it can be seen that the operational amplifier 100 outputs a stable band-gap reference voltage D or E even when the two input transistors of the operational amplifier 100 are realized in a process causing a mismatch of about 0.11% (1.1 mV) or about 1% (10 mV). Meanwhile, “C” in FIG. 4 represents a band-gap output generated in a matched state (mismatch of about 0% (0 mV)) of the two input transistors of the operational amplifier 100.

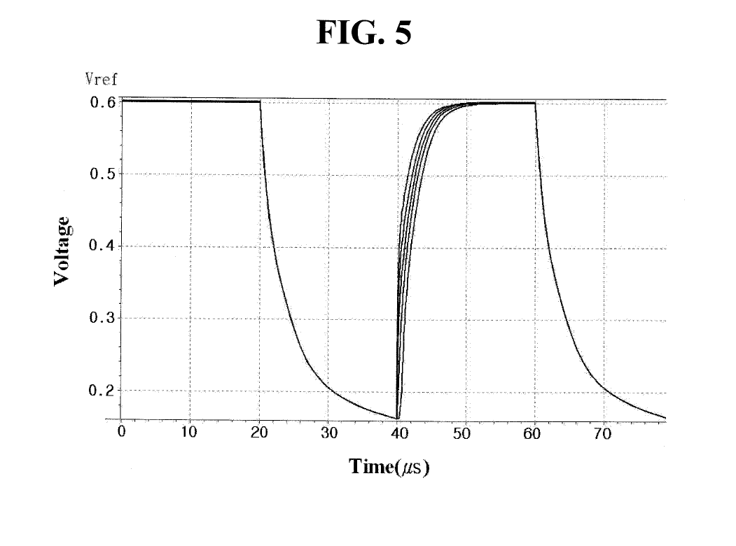

FIG. 5 is a simulation graph depicting a band gap output of about 0.6V generated when the supply voltage VDD ranges from about 1.62V to about 3.6V, in accordance with embodiments. A wide range of supply voltage VDD, for example ranging from about 1.62V to about 3.6V is supported because the PMOS transistor PM1 and resistor R1 are connected in series, the PMOS transistor PM2 and resistor R2 are connected in series, and the resistors R2 and R3 are connected in parallel. Even in the wide range of the supply voltage VDD from about 1.62V to about 3.6V, it is possible to obtain a stable band-gap output of 0.6V, as shown in FIG. 5.

The reference voltage generation circuit according to embodiments, which is used for a band-gap reference voltage generation circuit, provides the following effects. First, stability is maximized by reducing the wake-up time in the start-up operation of the reference voltage generation circuit. Second, it is possible to achieve stable start-up when the operation mode is switched from the idle mode to the active mode (normal mode), and thus to rapidly obtain a stable output voltage. Third, it is possible to output a stable band-gap reference voltage of about 0.6V when the operation mode is switched from the idle mode to the active mode, even when the two input transistors of the operational amplifier are realized in a process causing a mismatch of about 1%, and thus to maximize the stability of the band-gap output.

Fourth, it is possible to achieve normal wake-up when the operation mode is switched from the idle mode to the active mode, even when the resistors and bipolar transistors at the input stages of the operational amplifier are realized in a process causing a mismatch of about 30%. Fifth, it is possible to support the supply voltage VDD in a wide range of voltages such as, for example, from about 1.62 to about 3.6V, and to obtain a stable band-gap output of about 0.6V within the wide range of the supply voltage VDD from 1.62V to 3.6V.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
an operational amplifier for outputting a constant voltage in accordance with reference voltages respectively input to an inverting terminal of the operational amplifier and a non-inverting terminal of the operational amplifier; and
a start-up circuit for waking up the operational amplifier when the start-up circuit is switched from an idle mode to an active mode, the start-up circuit comprising a first first-type transistor having a gate connected to an output of the operational amplifier, a source connected to a supply voltage, and a drain connected to first and second resistors, to supply a constant reference current to the first and second resistors in accordance with an output voltage from the operational amplifier, thereby generating a band-gap output voltage,
wherein the first and second resistors are connected in parallel to a stage from which the band-gap output voltage is output.

2. The apparatus of claim 1, wherein the start-up circuit includes:
a low pass filter comprising a second first-type transistor and a first second-type transistor, to remove radio-frequency noise from the band-gap output voltage; and
a second second-type transistor for controlling the band-gap output voltage to be 0V in the idle mode.

3. The apparatus of claim 1, wherein the second first-type transistor of the low pass filter has a gate, and a source connected between the first and second resistors while being connected to the gate of the second first-type transistor.

4. The apparatus of claim 2, wherein the second first-type transistor of the low pass filter has a drain connected to a gate of the first second-type transistor.

5. The apparatus of claim 2, wherein the first second-type transistor has a source connected to a ground voltage, and a drain connected to the ground voltage.

6. The apparatus of claim 1, wherein the start-up circuit further includes:
a second first-type transistor having a source connected to the supply voltage, a gate, and a drain connected to the gate of the second first-type transistor, the second first-type transistor being turned on when the start-up circuit is switched from the idle mode to the active mode;
a first second-type transistor having a drain connected to the drain of the second first-type transistor, the first second-type transistor being turned off when the start-up circuit is switched from the idle mode to the active mode, thereby causing the supply voltage to be charged, as a drain voltage, in the drain of the first second-type transistor;
a second second-type transistor having a gate connected to the drain of the second first-type transistor and the drain of the first second-type transistor, and a drain connected to the output of the operational amplifier, the second second-type transistor being turned on by the voltage charged in the drain of the first second-type transistor; and
third and fourth second-type transistors each having a gate connected to a stage supplying an inverted power-down signal generated when the start-up circuit is switched from the idle mode to the active mode, the third and fourth second-type transistors being simultaneously turned on by the inverted power-down signal.

7. The apparatus of claim 6, wherein the first second-type transistor has a gate connected to the drain of the first first-type transistor, and a source connected to a drain of the fourth second-type transistor.

8. The apparatus of claim 6, wherein the second second-type transistor has a source connected to a drain of the third second-type transistor.

9. The apparatus of claim 6, wherein each of the third and fourth second-type transistors has a source connected to a ground voltage.

10. The apparatus of claim 6, wherein the third and fourth second-type transistors are turned off by the inverted power-down signal in the idle mode, and the first second-type transistor is turned off by a band-gap output voltage of about 0V generated in the idle mode.

11. The apparatus of claim 1, comprising:
second and third first-type transistors each having a source connected to the supply voltage, each of the second and third first-type transistors outputting a bias current corresponding to the output voltage from the operational amplifier, using the supply voltage;
a reference voltage circuit comprising first and second nodes respectively connected to the inverting and non-inverting terminals of the operational amplifier, to supply the reference voltages to the inverting and non-inverting terminals of the operational amplifier via the first and second nodes, using the bias currents output from the second and third first-type transistors, respectively; and
a fourth first-type transistor having a source connected to the supply voltage, a gate connected to a stage supplying an inverted power-down signal, the fourth first-type transistor supplying the supply voltage to the second and third first-type transistors in accordance with the inverted power-down signal.

12. The apparatus of claim 11, wherein:
each of the second and third first-type transistors has a gate connected to the output of the operational amplifier;
the second first-type transistor has a drain connected to the first node of the reference voltage circuit; and
the third first-type transistor has a drain connected to the second node of the reference voltage circuit.

13. The apparatus of claim 11, wherein the fourth first-type transistor has a drain connected to the gates of the second and third first-type transistors.

14. The apparatus of claim 11, wherein the reference voltage circuit includes:
a third resistor and a first bipolar transistor which are connected in parallel to the first node and the ground voltage;
a fourth resistor and a second bipolar transistor which are connected in parallel to the second node and the ground voltage; and
a fifth resistor connected in series between the second node and the second bipolar transistor.

15. The apparatus of claim 14, wherein:
the third resistor is connected to the second first-type transistor in series, and the fifth resistor is connected to the third first-type transistor in series while being connected to the fourth resistor in parallel;
the first and second bipolar transistors have bases connected to the ground voltage, to constitute a current mirror;
the first bipolar transistor has an emitter connected to the first node, and a collector connected to the ground voltage; and
the second bipolar transistor has an emitter connected to the fifth resistor, and a collector connected to the ground voltage.

16. The apparatus of claim 11, wherein the fourth first-type transistor is turned on in the idle mode, and the output of the operational amplifier is charged with the supply voltage as the fourth first-type transistor is turned on, so that the second and third first-type transistors are turned off.

17. The apparatus of claim 1, wherein the first first-type transistor supplies a constant reference current to the first and second resistors, to generate a band-gap output voltage of about 0.6V.

18. The apparatus of claims 1, wherein the first-type transistors are P-channel type MOS transistors, and the second-type transistors are N-channel type MOS transistors.

19. A method comprising:
outputting a constant voltage from an operational amplifier in accordance with reference voltages respectively input to an inverting terminal of the operational amplifier and a non-inverting terminal of the operational amplifier; and
waking up the operational amplifier with a start-up circuit when the start-up circuit is switched from an idle mode to an active mode, the start-up circuit comprising a first first-type transistor having a gate connected to an output of the operational amplifier, a source connected to a supply voltage, and a drain connected to first and second resistors, to supply a constant reference current to the first and second resistors in accordance with an output voltage from the operational amplifier, thereby generating a band-gap output voltage,
wherein the first and second resistors are connected in parallel to a stage from which the band-gap output voltage is output.

20. The method of claim 19, wherein the start-up circuit includes:
a low pass filter comprising a second first-type transistor and a first second-type transistor, to remove radio-frequency noise from the band-gap output voltage; and
a second second-type transistor for controlling the band-gap output voltage to be 0V in the idle mode.
